(19) United States
(12) Patent Application Publication
(10) Pub. No.: US 2013/0191370 A1
(43) Pub. Date: Jul. 25, 2013

(54) System and Method for Querying a Data Stream

(71) Applicants: Qiming Chen, Cupertino, CA (US); Meichun Hsu, Los Altos Hills, CA (US)

(72) Inventors: Qiming Chen, Cupertino, CA (US); Meichun Hsu, Los Altos Hills, CA (US)

(21) Appl. No.: 13/825,019

(22) PCT Filed: Oct. 11, 2010
(86) PCT No.: PCT/US2010/052171

§ 371 Date: Mar. 19, 2013

(51) Int. Cl. G06F 17/30

(52) U.S. Cl. CPC G06F 17/30463
USPC 707/718

(57) ABSTRACT

There is provided a method (200) for querying a data stream. The method includes receiving a query plan based on a query specifying the data stream and a window. The method (200) further includes receiving one or more stream elements from the data stream during the window. Additionally, the method (200) includes applying the query to the one or more stream elements by passing the one or more stream elements from a scan operator at a leaf of the query plan to an upper layer of the query plan on a tuple-by-tuple basis. The method (200) also includes committing a result of the query based on the one or more stream elements.

### BACKGROUND

Live-BI (Business Intelligence) is a data-intensive and knowledge-rich computation chain where dynamically collected and statically stored data are used in combination. Dynamically collected data typically includes streaming data, such as traffic data, e.g., number of vehicle moving on and off expressways. Statically stored data may be historical. In Live-BI, dynamic and static data are useful for analyzing dynamic data within a historical context.

Dynamic data may be provided via a data stream management system. Data stream management systems are typically, read-only. Further, data stream managements systems may not provide transactions, and only make informal guarantees of correctness. Without transactions, it is not possible to actively query streaming data.

Typically, historical data resides in a data warehousing environment. In the data warehousing environment, historical data may be queried after being loaded through an extract, transform, and load (ETL) process. Today, the platforms for analyzing data streams and data warehouses may be separate. This separate approach may be used to avoid read/write conflicts. This separation is a bottleneck for scalability and efficiency, due to the overhead in data access and data transfer.

### BRIEF DESCRIPTION OF THE DRAWINGS

Certain embodiments are described in the following detailed description and in reference to the drawings, in which:

FIG. 1 is a block diagram of a system for querying a data stream according to an example embodiment of the present invention;

FIG. 2 is a data flow diagram showing continuous querying of a data stream according to an example embodiment of the present invention;

FIG. 3 is a graph showing the performance of continuous querying of data streams according to an example embodiment of the invention;

FIG. 4 is a graph showing the performance of continuous querying of data streams according to an example embodiment of the invention;

FIG. 5 is a block diagram of a system adapted to query data streams according to an example embodiment of the present invention; and

FIG. 6 is a block diagram showing a non-transitory, machine-readable medium that stores code adapted to query data streams according to an example embodiment of the present invention.

### DETAILED DESCRIPTION

Query processing can be considered to be similar to a streaming operation in the sense that the operators on a query tree (except the scan operators) are applied to data tuple by tuple. However, a query is defined on the entire data set. In contrast, a query against a data stream may be defined on a single tuple, or a chunk of tuples, or a sliding window, of an unbound data set.

Due to these differences, most existing stream processing systems (e.g. CQL, TelegraphCQ, and System 8) are built from scratch. As such, they fail to leverage existing DBMS technology to manage historical data, transactions, recovery, workload, etc. Accordingly, as stream processing systems evolve, more and more such data management functionalities have to be re-developed.

However, a unified platform may be used that supports analysis over both streaming and historical data. This platform may be part of a system for querying a data stream.

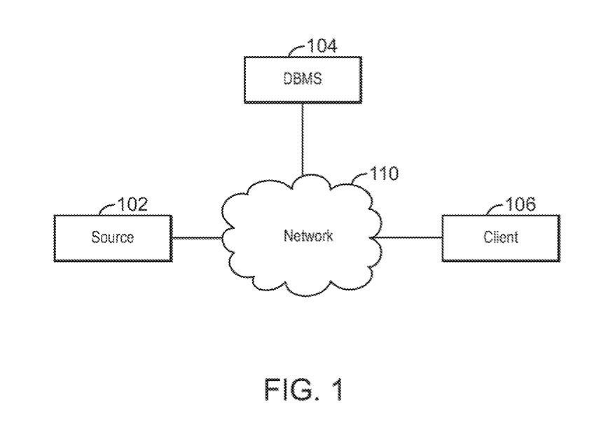

FIG. 1 is a block diagram of a system 100 for querying a data stream according to an embodiment of the present invention. The system 100 may include a source 102, a database management system (DBMS) 104, and a client 106, coupled to a network 110.

The source 102 may provide a data stream to the DBMS 104. The DBMS 104 may also compile and execute queries submitted from a client 106. The queries may generate results based on historical data in the DBMS 104, or data streams from one or more sources 102.

The DBMS 104 may include a continuous-query-based, stream processing oriented transaction model. In this model, continuous persisting may be integrated with continuous querying. In other words, a continuous query may continuously persist its results within a single query instance.

The integration of continuous querying and continuous persisting may provide challenges. For example, the data stream may be an unbound source of data. In other words, the data stream may not have an “end of data” condition that normally terminates a query. As such, a query against the data stream may not be able to end.

Typically, queries are run within transactions. Once the query completes, the transaction commits the results of the query. If the query does not complete, the transaction does not commit the results. As such, the results may not be available to the client 106. Also, any data stored by a query may not be available for other transactions to view or update.

Two typical approaches for processing a stream of data elements, include per-element processing and window-based processing. Per-element processing may be characterized by per-tuple query processing. Windows-based processing may be characterized by applying the same query to chunks of data (multiple stream elements) being received during windows divided by time or other conditions.

The former is a special case of the latter when the window-size is limited to a single tuple. Further, when a query merely includes simple select/project/join operators (without aggregate operators), applying one instance of the query to the stream tuple by tuple, or applying multiple instances of the query to data chunks, may yield the same sequence of results.

A continuously running transaction for processing unbounded stream data may never commit. Accordingly, such a transaction may never make its results accessible to other applications.

Further, the redo, undo, or in general, the ACID property of a longstanding transaction, even if not endless, may be difficult for the DBMS 104 to support. In database systems, correctness criteria are usually defined in terms of the ACID properties of transactions. In other words, database operations may be grouped into atomic transactions. The DBMS may guarantee that an application's transactions are executed in a manner that is equivalent to some serial ordering.

However, in data stream management systems, instead of focusing on operation serialization, the focus is data-oriented. Data stream management systems may provide guarantees about the movement of data into, within, and out of the data stream management system.

In one embodiment of the invention, transaction boundaries in a database may be associated with window boundaries in a data stream. The data stream's window may be a basic unit for data flow in the DSMS. For example, windows of time may be used as the unit of isolation. Further, the windows may represent units of durability for archived data streams, and the output streams of the queries against the data streams.

In such an embodiment, a continuous query may commit results periodically within a single transaction. By committing the results periodically, the query results may be available to other transactions even though the continuous query transaction is still running. The periods for committing results, referred to herein as cycles, may be consistent with the window semantics of stream processing. In one embodiment of the invention, the isolation level of the continuous query may be cycle-based read committed.

In some scenarios, a continuous query may deposit, e.g., insert, results in database tables. Typically, other transactions attempting to access these results may encounter conflicts that prevent access. However, the data that the continuous query inserts in a table may be accessible to other transactions. In one embodiment of the invention, updates may be made during a cycle using only record level locking. The data may be available even though the continuous query is still running.

With the continuous query, the same query instance may be applied cycle by cycle to a data stream. All elements of the data stream that are received within a particular cycle may be processed as one chunk of data. The stream processing results may be persisted to the DBMS 104 by a sequence of cycle based transactions with chunk oriented isolation.

While allowing the stream processing transactions to commit cycle by cycle periodically, this approach enables per-cycle results to be available after the cycle ends. Since stream processing is a long standing operation and all the results are persisted into the same table, there may be a near-zero gap between two consecutive cycles.

While data may be accessible during these gaps, forcing other transactions to wait for these gaps may hurt the performance of the DBMS 104. As such, all the results, except those generated during the current cycle, may be accessible to other transactions.

With the conventional database system, the result of a SELECT operation and that of an UPDATE operation may have different receivers, i.e., destinations. The results of a SELECT operation may flow to the client 106, while the results of an UPDATE may flow to a table in the DBMS 104.

With the continuous query, the data stream may continuously flow to the client 106 and be continuously stored into the DBMS 104. Further, the resulting data being persisted by a transaction may remain accessible through continuous querying.

The continuous query may be long-running, but the data processed may be transient. The data may be considered transient because each cycle of the continuous query may process a different chunk of the data stream. As such, each chunk-oriented continuous query evaluation may be considered a running cycle of the continuous query.

The boundary of a data chunk, such as the data falling in a 5 minute window, may be predetermined. Therefore, committing the results of a continuous query based on the window boundary may, in general, be consistent with the application semantics of transactions.

More specifically, consistent with the query cycle based transaction boundaries, chunk-based isolation may be enforced. Chunk-based isolation merely means that each cycle only processes the chunk of data from the stream received during the corresponding window of the cycle.

For example, given a continuous query that inserts new rows in a table, all the new rows inserted by the transaction may be stored in the same table. However, the rows may be inserted cycle by cycle, with each cycle corresponding to a specific set of rows that correspond to the chunk of the data stream processed by that cycle.

During each cycle, the inserted data may be subject to the read-committed isolation level, and be row-exclusive locked. Accordingly, the data inserted during a cycle may be accessible to public after the cycle ends. Once committed, cycle results may be accessible regardless of what other cycle-based transactions may be running on the same table.

In one embodiment of the invention, the execution engine of the DBMS 104 may be extended such that the DBMS 104 may include a unified Live-BI platform for both stream processing and data management. In such an embodiment, the full SQL expressive power of the DBMS may be applied to a data stream chunk by chunk.

At the same time, the execution history may remain continuously tractable in a long-standing, continued query execution instance. The proposed query-cycle based transaction model, data chunk oriented isolation and locking management represent an initial step toward the leverage of database transaction management for stream processing.

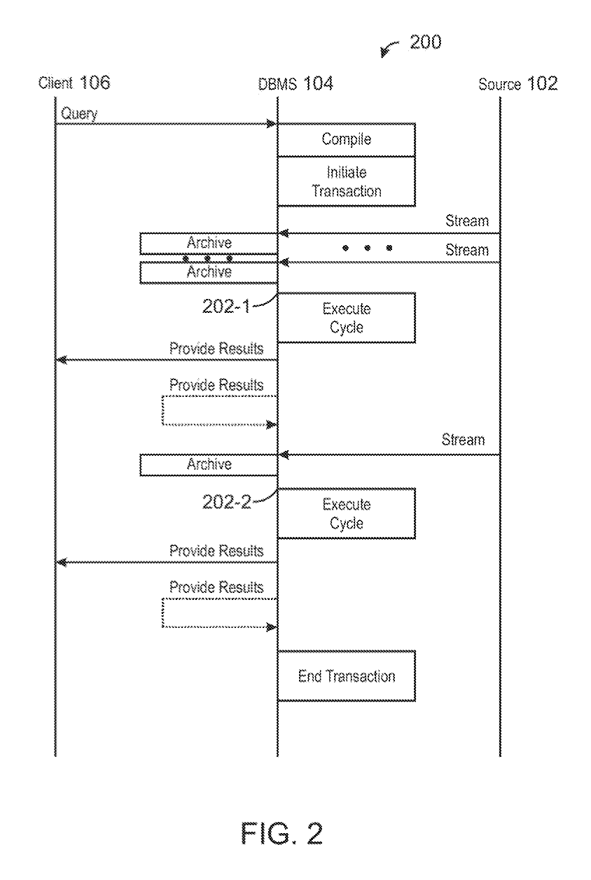

FIG. 2 is a data flow diagram 200 showing continuous querying of a data stream according to an embodiment of the present invention. As stated previously, the client 106 may submit a query for the data stream to the DBMS 104.

In one embodiment of the invention, the query may specify cycle and window parameters, and identify a data stream. For example, the query may specify that data stream elements received within each 60-second window may be processed during one cycle of the continuous query. The query may also specify that the continuous query processes 180 cycles. In such a case, the continuous query may process 3 hours of data received from a data stream, i.e., 180 one-minute cycles.

The stream specified in the continuous query may be used similarly to other data structures referenced in a typical query. For example, the query may join the stream to a database table, view, or another stream. In a scenario where a stream is joined to a static, e.g., historical, table, each chunk of the stream may be joined with that table.

The DBMS 104 may compile the query. Compiling the query may include parsing and optimizing the query into a query plan, e.g., a tree of operators.

After compiling, the DBMS 104 may initiate a transaction for the continuous query. In one embodiment of the invention, execution engine may interact with a user defined function to initiate the transaction. In such an embodiment, the query may specify the user defined function. The user defined function may be configured with an extended function call handle that is accessible to both the function and the DBMS execution engine. The execution engine and the user defined function may interact in allocating initial memory for the continuous query.

Once initiated, the continuous query may archive all stream elements falling in a time window, e.g., 1 minute, or a granule (e.g., 100 tuples). The time window and the granule may be interval specific or sliding. In one embodiment of the invention, the execution engine of the DBMS 104 may include history-sensitive window operators for incrementally and collectively archiving the stream elements.

For example, a stream source function may be used as a new kind of data source. The stream source function may listen or read data/events sequence from the data stream.

At the end of a time window 202-1, the DBMS 104 may execute a cycle of the continuous query. Typically, during execution, a scan operator at the leaf of the tree may retrieve and materialize a block of data (e.g., a data stream chunk). Materializing the block of data may include delivering the data stream chunk to upper layers of the tree, tuple by tuple.

However, in one embodiment of the invention, the scan method may be extended to retrieve stream elements from the stream source function on a per-tuple basis. Additionally, the stream source function may explicitly control the “end-of-data” signal for terminating each cycle.

A cut-and-rewind approach may be used for each cycle of the continuous query. In other words, a query execution may be cut based on a corresponding chunk, and then rewound for processing the next chunk of the data stream.

The continuous query may be rewound (rather than shut down and restarted) for processing the subsequent data chunk in the next cycle. In a scenario where the query specifies a join of multiple streams, the query rewinding point may serve as a synchronization point This approach may resolve two conflicting details of query based stream processing: 1) apply a SQL query to a data stream one chunk at a time, and 2) continuously maintain a required state across the execution cycles for dealing with sliding windows, etc.

It should be noted that, in each execution cycle, the continuous query may return the result of processing the current chunk, but an operator of the query, including a user defined function, may be invoked one tuple at a time.

Keeping the query execution instance alive may allow the memory context and per-tuple processing history to be buffered in an operation node. This buffering may be sustained across multiple cycles. Using the cut-and-rewind approach allows applying SQL to data stream chunk by chunk within in a single, truly continuous query execution instance.

Additionally, the execution engine and the user defined function may buffer per-tuple cycle results to be carried onto the next cycle. Because a continuous query instance rewinds but never shut down, the buffered state can be sustained across query execution cycles as long as the continuous query execution instance is alive. Further, any static data required for the UDF computation can be pre-loaded during transaction initiation. A list of window user defined function shells may pre-defined as one way to extend the execution engine accordingly.

As mentioned above, the source stream function may issue the “end-of-data” signal to instruct the execution engine to terminate the current cycle, and return the query results on the current chunk. Typically, queries select, project, or join operations are different from queries that insert, delete, or update in the flow of resulting data. In a select/project/join query, the destination of results is a query receiver connected to the client 106. In insert/update/delete query, the destination of the results may be a database table.

In one embodiment of the invention, the results may be provided to the client 106 and the database tables (via the DBMS 104). This may be done with efficient heap-insertion. This two-receiver approach may make the persisting of results to the client 106 an automatic side effect of streaming. For example, typically, the results of a “select into” statement go to the database table only.

In such an embodiment, the execution engine may fork the query results to the two receivers. In this way, the continuous query results may flow to the client 106 continuously, and be stored in the DBMS 104 simultaneously. Specifically, the execution engine may be extended to provide the cycle based SELECT INTO and INSERT INTO with the two result destinations.

In between cycles, more stream elements may be received and archived. At the end of the window 202-2, the next cycle may be executed.

Because the continuous query is continuously persisting results, storage may become crowded. During normal database operation, storage that is occupied by deleted or obsolete tuples are not physically removed from their tables. Instead, these tuples may they remain present until a DBMS utility cleans them up, e.g., the vacuum utility in PostgreSQL.

Typically, the DBMS 104 periodically cleans up storage, especially on frequently updated tables. However, during continuous querying, the results are committed cycle by cycle, with virtually no gaps in between. As such, it may be useful to also clean up the storage during the continuous query.

In one embodiment of the invention, for every N cycles, a specific cleanup operation may be invoked to reclaim space, and make the reclaimed space available for re-use. Two possible approaches to this cleanup operation include a concurrent cleanup, and an embedded cleanup.

The concurrent cleanup may operate in parallel with the continuous query. The concurrent cleanup may not lock tables exclusively. As such, the concurrent cleanup may operate in parallel with the normal reading and writing of the tables.

An embedded cleanup may be explicitly embedded in the cycle control flow of the continuous query. The embedded cleanup may runs every N cycles with an exclusive lock obtained, for moving tuples across blocks to try to compact the table to the minimum number of disk blocks.

As the embedded cleanup may use an exclusive lock on the table, for cost saving purposes, the cleanup operation may only be applied to the direct insert without using write-ahead logging.

Once the final cycle completes, and the results for the last chunk are provided to the client 106 the DBMS 104, the DBMS 104 may end the transaction.

As stated previously, the SELECT INTO and INSERT INTO may be extended by the query engine to support continuous querying with continuous persisting on a data stream. The normal SELECT INTO and INSERT INTO behaviors may be unchanged.

With regard to the SELECT INTO, per-cycle query results may be heap-inserted to the specified tables. Additionally, the SELECT INTO may be extended to allow selecting into an existing relation. Selecting into an existing relation may be accomplished by allowing appending to an existing table with a matching schema.

Persisting stream processing results through the extended SELECT INTO may include direct loading. In direct loading, the data inserted to heap are deposited to disk without logging. This approach may be suitable for persisting data that is not to be immediately retrieved.

The execution engine may also be extended for the INSERT INTO . . . SELECT . . . FROM operation. Similar to the extended SELECT INTO described above, the per-cycle query results may be heap-inserted to the specified table under the cycle-transaction mechanism.

Persisting stream processing results through the extended INSERT INTO may result in heap synchronization and write ahead logging. As such, the data inserted to the heap may remain in the main memory for a while, and then written to disk by the database writer based on a specified policy. As a result, newly inserted data in a continuous query cycle may be retrieved from the memory immediately after the cycle commits.

In addition to the updates provided by a SELECT INTO and an INSERT INTO, the continuous query may allow user defined functions with update effects. Using a user define function, certain intermediate stream processing results may be stored in the DBMS 104. To do so, the user defined function may be relaxed from read-only mode, and employ the database internal query facility to form, parse, plan and execute queries efficiently. In an embodiment using the PostgreSQL server, the PostgreSQL SPI (Server Program Interface) may be used.

With the update effects of one or more user defined functions, the continuous query may no longer read-only by itself. Executed cycle by cycle, the continuous query may follow the cycle based transaction boundary, committing after each cycle before a rewind. This may enable a user defined function's update effects to be accessible to public after the cycle is complete.

To support results persisting from user defined functions, each cycle of a SELECT query may be placed within a transaction boundary. Additionally, row-exclusive lock may be used for tables updated through the SPI from the user defined functions. Accordingly, intermediate results of the continuous query may be inserted to tables by user defined functions.

Persisting stream data using the cut-and-rewind approach has three performance advantages. First, rewinding the continuous query is more efficient than a conventional tear-down/restart. Second, since the query is not shut-down, the UDP state (e.g. for sliding window) may be sustained. Otherwise, the data may need to be copied to some shared memory because the next query execution would be a different backend process. Third, directly inserting the data to a heap during the continuous query processing avoids the overhead in parsing, planning and setting up multiple database update operations.

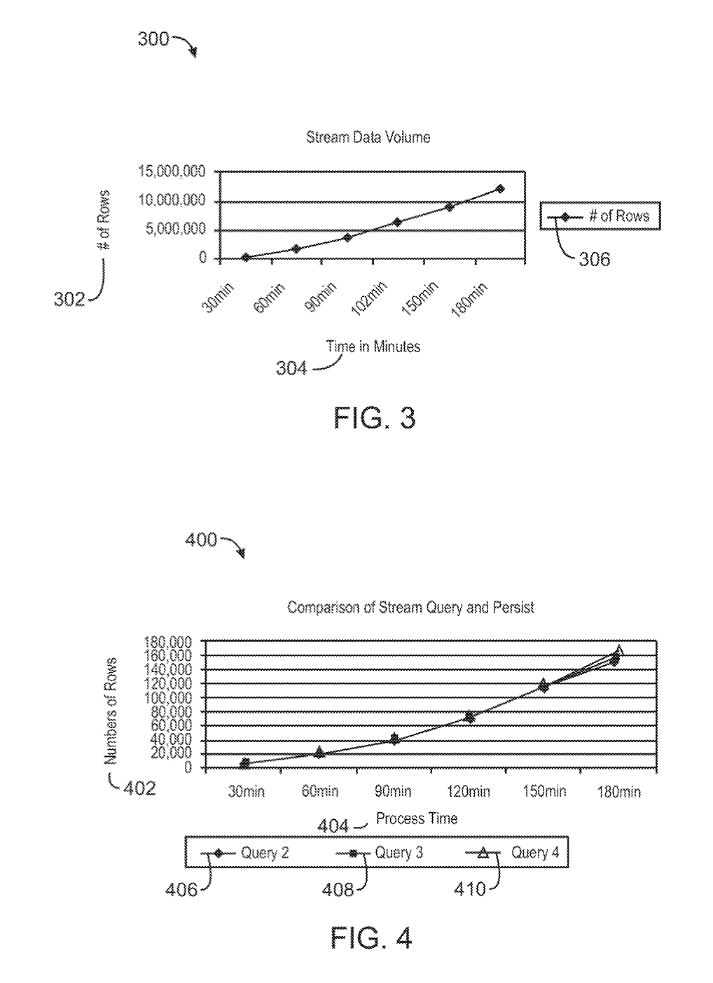

FIG. 3 is a graph 300 showing the performance of continuous querying of data streams according to an embodiment of the invention. This approach has been tested using the widely-accepted Linear-Road benchmark that models the traffic on multiple expressways for a 3 hour duration. In the benchmark, each expressway has 3 lanes in each direction, and each lane has multiple segments. Cars enter and exit the lanes at segment boundaries, and the position of each car is read every 30 seconds and each reading constitutes a streaming event for.

At L=I, the benchmark consists of one expressway, with an event arrival rate ranging from a few hundred per second to a peak of 1,700 events/second at the end of the 3-hour duration. The LI setting was chosen for our experiment.

Each record gives the current location and speed of a car. Computation of the segment statistics, i.e. the number of active cars, average speed, and the 5-minute moving average speed, dimensioned by expressway, direction and segment, has been recognized as the bottleneck of the benchmark.

The streaming tuples are generated by the source stream function, STREAM_CYCLE_LR(time, cycles), from the Linear Road input data, where the parameter “time” is the time-window size in seconds. Cycles is the number of cycles the continuous query is run. For example, STREAM_CYCLE_LR(60, 180) delivers the tuples falling every minute (60 seconds) to be processed in one execution cycle, 180 times (for 3 hour or 180 minutes).

Unlike other reported LR implementations where segment statistics are calculated by ad-hoc programs, continuous querying makes it possible to have these two continuous statistics measures generated by the query engine directly in the following single, long standing SQL query:

```
SELECT p.minute, p.xway, p,dir, p.seg, p.active_cars,
        Lr_moving_avg.(0, xway, dir, seg, minute, avg_speed)
        AS past_5m_avg_speed
        FROM (SELECT FLOOR (time, 60) ::integer
        AS minute, xway; dir, seg,
        AVG(speed) AS avg_speed,
        COUNT (distinct Vid)-l AS active_cars
        FROM STREAM_CYCLE_lr_producer {60, 180)
        GROUP BY minute, xway., dir, seg ) p;
```

### QUERY 1

QUERY 1 may repeatedly apply to the data chunks falling in 1 minute time-windows, and rewinds 180 times in the single query instance. The sub-query with alias, “p,” may yield the number of active cars and their average speed for every minute dimensioned by segment, direction and expressway. The SQL aggregate functions are computed for each chunk with no context carried over from one chunk to the next.

The dimensioned moving average speed in the past 5 minutes is calculated by the sliding window function lr_moving_avg( ). This function buffers the per-minute average speed for accumulating the 5-minute moving average. Since the query is only rewound but not shut down, the buffer may sustain continuously across query cycles—providing an advantage of cut/rewind over the conventional shutdown/restart.

Besides the modeling power, our experimental result also shows the superior performance of processing data stream directly by the query engine. The Linear Road benchmark typically requires the segment toll to be calculated majorly based on the above two segment statistics. Using the continuous query, the toll computation for the 3-hour benchmark period was completed in about 2 minutes—which indicates that the engine is capable of handling much higher number of lanes. The total simulated computation time with LI setting on the downloaded Linear Road input data from 10 minutes up to 180 minutes (the full LR data) is illustrated in the graph 300.

The graph includes a y-axis 302 for the number of rows/tuples received from the data stream, an x-axis for the time in minutes to process the stream data, and a line 306 showing the time to process versus the stream volume.

FIG. 4 is a graph 400 showing performance of continuous querying of data streams according to an embodiment of the invention. The graph compares the performances three different SQL statements. QUERY 2 is used to calculate the tolls each minute in each segment of each expressway along each direction:

```
SELECT minute, xway, dir, seg, r.volume, r.mv_avg,
        r.ok*2*(r.volume−150)*(r.volume−150) as toll
FROM
(
SELECT p.minute as minute, p.xway as xway, p_dir as dir, p.seg as seg,
        p.active cars as volume,
        lr_moving_avg(O, xway, dir, seg, minute, minute_avg_speed)
        as mv_avg,
        p.ok as ok
FROM (
        select floor(time/60) ::integer as minute, xway, dir, seg,
            avg(speed) as minute avg speed,
            count (distinct Vid)-l as-active cars,
            min(lr acc affected(O,vid,speed-;-xway,dir,seg,pos)) as ok
        from STREAM_CYCLE_lr_producer (60, 180, 1)
        where dir >~ 0 and seg >= 0
        group by minute, xway, dir, seg
        ) p
) r
WHERE r.mv_avg > 0 and r.mv_avg < 40
```

### QUERY 2

QUERY 3 is used to persist the results along the above calculation, with direct disk insertion:

```
SELECT minute, xway, dir, seg, r.volume, r.mv_avg,
        r.ok*2*(r.volume−150)*(r.volume−150) as toll
INTO toll
FROM
(
        SELECT p.minute as minute, p.xway as xway, p.dir as dir, p.seg
          as seg,
          p.active cars as volume,
          lr moving avg(O, xway, dir, seg, minute, minute_avg_speed)
          as mv_avg,
          p.ok as ok
        FROM (
          SELECT floor (time/60) ::integer as minute, xway, dir, seg,
                avg(speed) as minute_avg_speed,
                count(distinct Vid)-l as active_cars,
                min(lr_acc_affected(O,vid,speed,xway,dir,seg,pos))
                as ok
          FROM STREAM_CYCLE_lr_producer(60, 180, 1)
                where dir >= 0 and seg >= 0
                group by minute, xway, dir, seg
        ) p
)r
WHERE r.mv avg > 0 and r.mv_avg < 40
```

### QUERY 3

QUERY 4 is also used to persist the results along the above calculation, but with write-ahead logging:

```
INSERT into toll
SELECT minute, xway, dir, seg, r.volume, r.mv avg,
        r.ok*2*(r,volume−150)*(r.volume−150) as toll -
FROM
(
        SELECT p.minute as minute, p.xway as xway, p.dir as dir, p.seg
            as seg,
        p.active cars as volume,
        lr_moving_avg(O, xway, dir, seg, minute, minute_avg_speed)
            as mv_avg,
        p.ok as ok
        FROM (
            SELECT floor (time/60) ::integer as minute, xway, dir, seg,
                avg(speed) as minute_avg_speed,
                count (distinct Vid)-l as active_cars,
                min(lr_acc_affected(O,vid,speed,xway,dir,seg,pos))
                as ok
            FROM STREAM_CYCLE_lr_producer(60, 180, 1)
            where dir >= 0 and seg >= 0
            group by minute, xway, dir, seg
        ) p
) r
WHERE r.mv_avg > 0 and r.mv_avg < 40;
```

### QUERY 4

As mentioned above, logging may slow down disk insertion. However, since the data are likely to be kept in memory for a while, the data can be retrieved efficiently.

The performance comparison is listed below in TABLE 1, and shown in the graph 400. These results show that integrating continuous querying and continuously persisting stream processing results does not incur significant overhead. This is because the update operations are pushed down to the core of query engine through direct heap insert without any extra overhead for query parsing, planning and setup, as well as data movement between the application and the query engine.

TABLE 1

| | | query | select into + | insert select + |
|---|---|---|---|---|
| | | display | display | display |
| LI | | (mini | (no logging, | (logging, |
| Minutes | % of rows | second) | sync disk) | buffer) |
| 30 | 500,531 | 5539 | 5713 | 6926 |
| 60 | 1,848,445 | 19330 | 20051 | 19655 |
| 90 | 3,839,053 | 40550 | 41057 | 40564 |
| 120 | 6,314,651 | 70753 | 71137 | 72158 |
| 150 | 9,106,963 | 113456 | 117104 | 118470 |
| 180 | 12,048,577 | 157878 | 159349 | 167746 |

The results in TABLE 1 are represented in the graph 400. The graph 400 includes a y-axis 402 for the number of tuples processed from the data stream, an x-axis 404 for the processing time, and lines 406, 408, and 410 to represent the processing time for the number of rows processed by QUERY 2, 3, and 4.

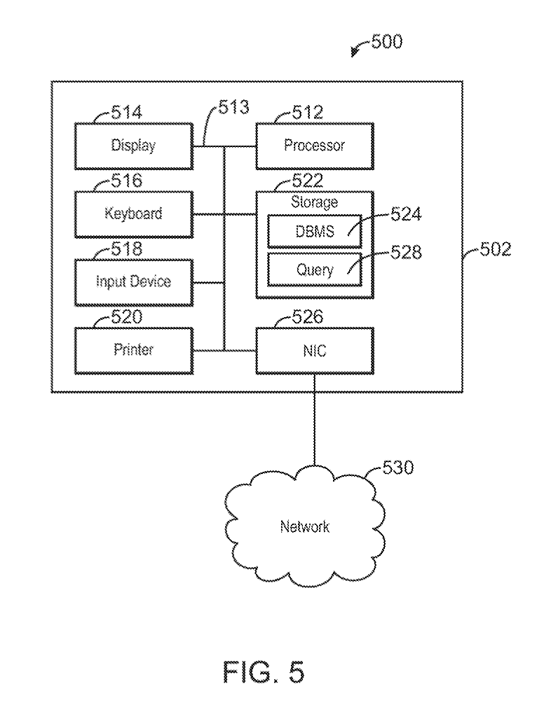

FIG. 5 is a block diagram of a system adapted to query data streams according to an embodiment of the present invention. The system is generally referred to by the reference number 500. Those of ordinary skill in the art will appreciate that the functional blocks and devices shown in FIG. 5 may comprise hardware elements including circuitry, software elements including computer code stored on a non-transitory, machine-readable medium or a combination of both hardware and software elements.

Additionally, the functional blocks and devices of the system 500 are but one example of functional blocks and devices that may be implemented in an embodiment of the present invention. Those of ordinary skill in the art would readily be able to define specific functional blocks based on design considerations for a particular electronic device.

The system 500 may include a server 502 and a network 530. As illustrated in FIG. 5, the server 502 may include a processor 512 which may be connected through a bus 513 to a display 514, a keyboard 516, one or more input devices 518, and an output device, such as a printer 520. The input devices 518 may include devices such as a mouse or touch screen.

The server 502 may also be connected through the bus 513 to a network interface card (NIC) 526. The NIC 526 may connect the database server 502 to the network 530. The network 530 may be a local area network (LAN), a wide area network (WAN), such as the Internet, or another network configuration. The network 530 may include routers, switches, modems, or any other kind of interface device used for interconnection.

Through the network 530, a source, such as the source 102 may provide a data stream to the server 502. The ETL server 502 may have other units operatively coupled to the processor 512 through the bus 513. These units may include, non-transitory, machine-readable storage media, such as a storage 522. The storage 522 may include media for the long-term storage of operating software and data, such as hard drives.

The storage 522 may also include other types of non-transitory, machine-readable media, such as read-only memory (ROM), random access memory (RAM), and cache memory. The storage 522 may include the software used in embodiments of the present techniques.

The storage 522 may include a DBMS 524 and a query 528. In an embodiment of the invention, the DBMS 524 may execute a continuous query based on the query 528. The continuous query may query a data stream, and commit results within cycles of a transaction.

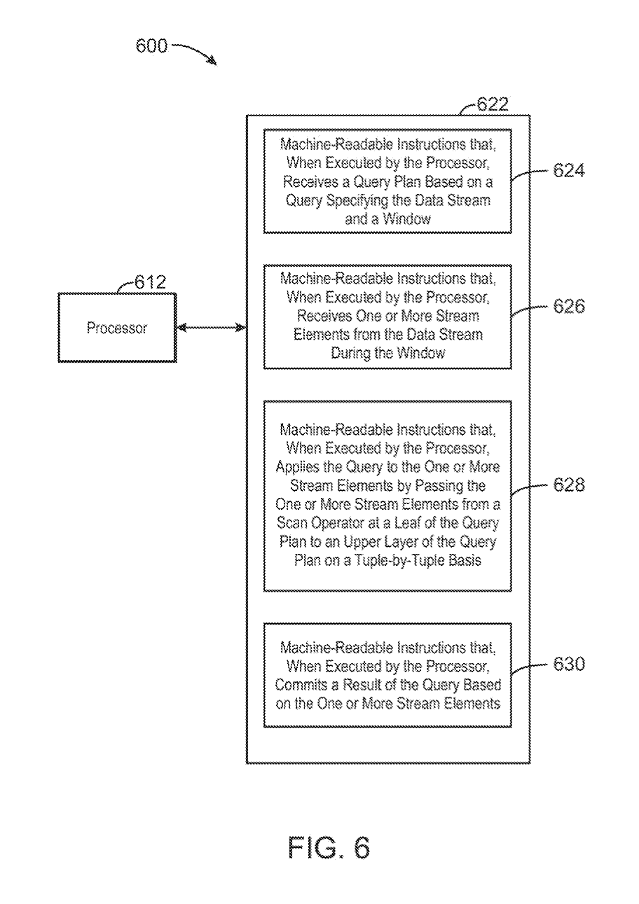

FIG. 6 is a block diagram showing a system 600 with a non-transitory, machine-readable medium that stores code adapted to query data streams according to an embodiment of the present invention. The non-transitory, machine-readable medium is generally referred to by the reference number 622.

The non-transitory, machine-readable medium 622 may correspond to any typical storage device that stores computer-implemented instructions, such as programming code or the like. For example, the non-transitory, machine-readable medium 622 may include a storage device, such as the storage 522 described with reference to FIG. 5.

A processor 602 generally retrieves and executes the computer-implemented instructions stored in the non-transitory, machine-readable medium 622 to query data streams.

A region 624 may include instructions that receive a query plan based on a query specifying a data stream and a window. A region 626 may include instructions that receive one or more stream elements from the data stream during the window.

A region 628 may include instructions that apply the query to the one or more stream elements by passing the one or more stream elements from a scan operator at a leaf of the query plan to an upper layer of the query plan on a tuple-by-tuple basis. A region 630 may include instructions that commit a result of the query based on the one or more stream elements.

What is claimed is:

1. A method (200) for querying a data stream, comprising:
receiving a query plan based on a query (528) specifying the data stream and a window;
receiving one or more stream elements from the data stream during the window;
applying the query (528) to the one or more stream elements by passing the one or more stream elements from a scan operator at a leaf of the query plan to an upper layer of the query plan on a tuple-by-tuple basis; and
committing a result of the query (528) based on the one or more stream elements.

2. The method (200) recited in claim 1, comprising:
providing the result to a client application (106): and
persisting the result to a database table.

3. The method (200) recited in claim 2, wherein the query (528) specifies one of:
an insert into operation; and
a select into operation.

4. The method (200) recited in claim 1, comprising:
initiating a transaction based on a user defined function specified in the query (528);
performing, during the transaction, a plurality of cycles corresponding to a plurality of windows, wherein the plurality of windows comprise the window, and wherein each of the cycles comprises:
receiving the one or more stream elements;
applying the query (528) to the one or more stream elements; and
committing the result.

5. The method (200) recited in claim 4, comprising performing a vacuum operation on obsolete data for the transaction periodically, wherein a period comprises a predetermined number of the plurality of cycles.

6. The method (208) recited in claim 1, comprising storing an intermediate result of the query (528) based on a user defined function.

7. The method (200) recited in claim 1, wherein the query (528) specifies a join of the data stream and at least one of the following:
a database table; and
another data stream.

8. A computer system (500) for querying a data stream, the computer system comprising a processor (512) configured to:
receive a query plan based on a query (528) specifying the data stream, a window, and a user defined function;
receive one or more stream elements from the data stream during the window;
apply the query (528) to the one or more stream elements by passing the one or more stream elements from a scan operator at a leaf of the query plan to an upper layer of the query plan on a tuple-by-tuple basis; and
commit a result of the query (528) based on the one or more stream elements.

9. The computer system (500) recited in claim 8, wherein the processor (512) is configured to:
provide the result to a client application 106); and
persist the result to a database table.

10. The computer system (500) recited in claim 9, wherein the query (528) specifies one of:
an insert into operation; and
a select into operation.

11. The computer system (500) recited in claim 8, wherein the processor (512) is configured to:
initiate a transaction based on the user defined function, wherein the user defined function is configured with an extended function call handle accessible to both the user defined function and a database management system execution engine, and wherein the execution engine and the user defined function are configured to interact to allocate initial memory for the transaction;
perform, during the transaction, a plurality of cycles corresponding to a plurality of windows, wherein the plurality of windows comprise the window, and wherein, during each of the cycles, the processor is configured to:
receive the one or more stream elements;
apply the query to the one or more stream elements; and
commit the result.

12. The computer system (500) recited in claim 11, comprising performing a vacuum operation on obsolete data for the transaction periodically, wherein a period comprises a predetermined number of the plurality of cycles.

13. The computer system (500) recited in claim 8, wherein the processor is configured to store an intermediate result of the query (528) based on a second user defined function.

14. The computer system (500) recited in claim 8, wherein the query (528) specifies a join of the data stream and at least one of the following:
a database table; and
another data stream.

15. A non-transitory, computer-readable medium (622) comprising machine-readable instructions executable by a processor (612) to query a data stream, the non-transitory, computer-readable medium (622) comprising:
computer-readable instructions (624) that, when executed by the processor (612), receive a query plan based on a query specifying an update operation, the data stream, a window, and a user defined function;
computer-readable instructions (626) that, when executed by the processor (612), receive one or more stream elements from the data stream during the window;
computer-readable instructions (628) that, when executed by the processor (612), initiate a transaction based on the user defined function;
computer-readable instructions (628) that, when executed by the processor (612), perform, during the transaction, a plurality of cycles corresponding to a plurality of windows, wherein the plurality of windows comprise the window, and wherein, during each of the cycles, the processor (612) is configured to:
receive the one or more stream elements;
apply the update operation to the one or more stream elements by passing the one or more stream elements from a scan operator at a leaf of the query plan to an upper layer of the query plan on a tuple-by-tuple basis; and
commit the result;
computer-readable instructions (630) that, when executed by the processor (612), provide the result to a client application; and
computer-readable instructions (630) that, when executed by the processor (612), persist the result to a database table.
